(19) United States
(12) Patent Application Publication
(10) Pub. No.: US 2014/0234668 A1
(43) Pub. Date: Aug. 21, 2014

(54) Battery Housing with Single-Side Electrical Interconnects

(71) Applicant: Faster Faster, Inc., San Francisco, CA (US)

(72) Inventors: Robert W. Sweney, San Francisco, CA (US); Derek Dorresteyn, Mill Valley, CA (US)

(21) Appl. No.: 13/934,076

(22) Filed: Jul. 2, 2013

Related U.S. Application Data
(60) Provisional application No. 61/766,550, filed on Feb. 19, 2013.

(51) Int. Cl. H01M 2/20

(52) U.S. Cl. CPC H01M 2/206
USPC 429/7; 429/99; 429/61

(57) ABSTRACT

A battery housing includes a battery frame that holds a plurality of battery cells. Each battery cell includes a positive terminal and a conducting structure at one end, a negative terminal at the opposite end, and a conductive shell that electrically couples the negative terminal to the conducting structure. An interconnect creates an electrical connection between two cells by contacting either the conducting structure or the positive terminal of each cell. The cells are positioned so that the positive terminals, conducting structures, and interconnect are all on the same side of the battery frame. As a result, the interconnect can be shorter in length.

### CROSS-REFERENCE TO RELATED APPLICATION

This application claims priority to U.S. Provisional Application No. 61/766,550, filed Feb. 19, 2013, which is incorporated by reference herein in its entirety.

### FIELD OF THE TECHNOLOGY

The present disclosure relates generally to battery housings, and in particular to electrical interconnects between cells in a battery housing.

### BACKGROUND

A battery housing typically includes electrical conductors that connect battery cells in series and/or in parallel configurations to form a battery system with a desired energy capacity and output voltage. On a cylindrical battery cell, the positive and negative terminals are positioned at opposite ends of the cell. Conventionally, electrical contact is made at both ends of each cell in the battery housing so that both the positive and negative terminals are directly connected to a conductor. However, making electrical contact at both ends of each cell increases the number of potential failure points in the connection system and increases the overall cost of the battery housing.

### SUMMARY

In one embodiment, a battery housing includes a battery frame that holds a plurality of battery cells. Each battery cell has a positive terminal at a first end and a negative terminal at a second end opposite to the first end. Each battery cell also includes a conducting structure at the first end and a conductive shell that electrically couples the negative terminal at the second end to the conducting structure at the first end. Rather than making electrical contact at both ends of a battery cell, an interconnect makes contact with the positive terminal or the conducting structure, both of which are at the first end of a cell. Since the conductive shell electrically couples the conducting structure to the negative terminal, making contact at the crimp structure of a cell has the effect of coupling the interconnect to the negative terminal of the cell.

In one embodiment, the interconnect between two cells makes contact with the conducting structure of a first battery cell and the positive terminal of a second battery cell to connect the two cells in series. In another embodiment, a first interconnect makes contact with the positive terminals of two battery cells, and a second interconnect makes contact with the crimp structures of the same two battery cells to connect the two cells in parallel.

The cells are positioned so that the first end of each cell and the interconnect are all on the same side of the battery frame, and the second end of each cell is at the opposite side of the frame. As a result, the interconnect can be shorter in length because it does not need to extend between opposite sides of the frame to connect opposite ends of battery cells. A shorter interconnect is advantageous because it allows for lower material and manufacturing costs. A shorter interconnect also reduces the number of potential failure points in the battery housing and reduces the overall complexity of the connections between the cells.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIGS. 1A-1C illustrate various views of a battery housing, according to one embodiment.

FIGS. 2A-2B illustrate a battery cell, according to one embodiment.

FIGS. 3A-3B illustrate interconnects for coupling battery cells to each other, according to one embodiment.

FIGS. 4A-4C illustrate alignment features within a cell compartment of the battery housing, according to one embodiment.

FIGS. 5A-5F illustrate a thermal management system for the battery cells, according to one embodiment.

FIG. 6 illustrates a battery assembly mounted on an electric motorcycle, according to one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Battery Housing Overview

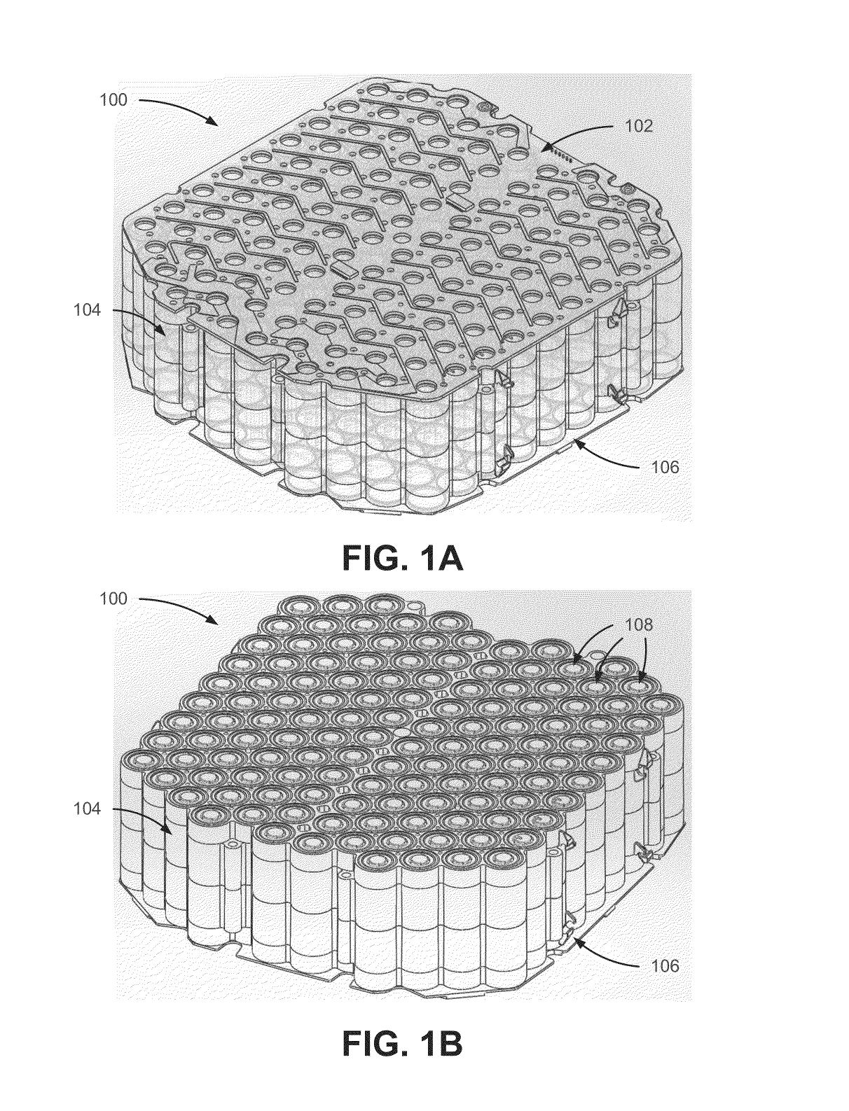

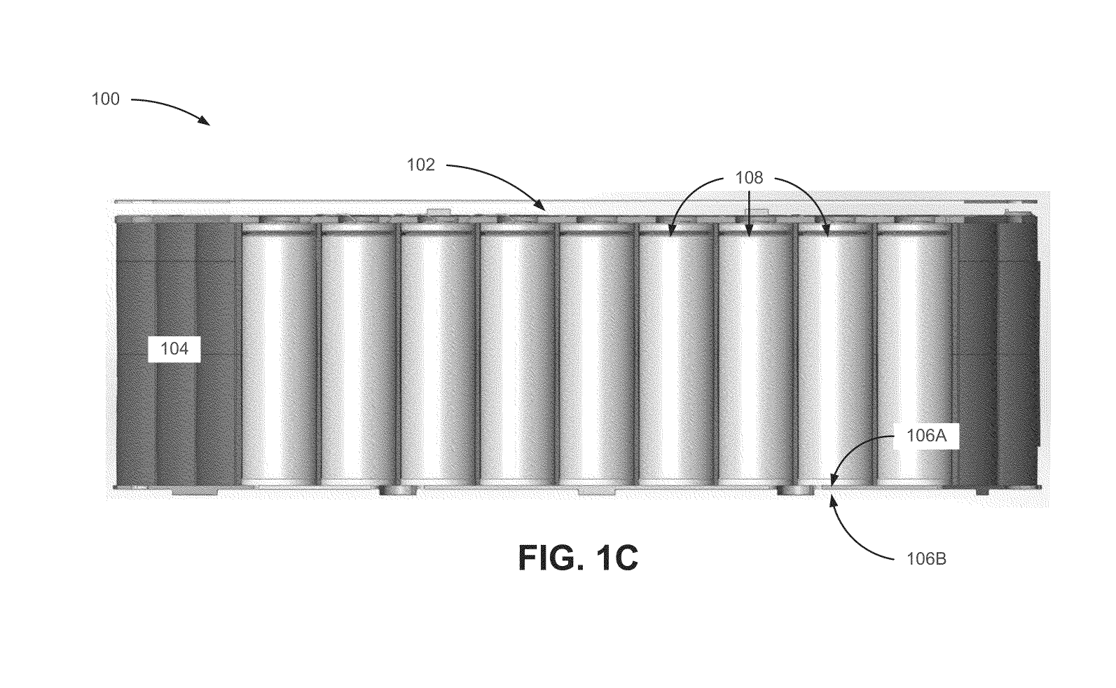

FIG. 1A is a perspective view of a battery housing 100, according to one embodiment. The battery housing 100 includes a circuit board 102, a frame structure 104, and a heat spreader 106. FIG. 1B is a perspective view of the battery housing 100 with the circuit board 102 removed. As shown in FIG. 1B, the frame structure 104 contains compartments for battery cells 108. FIG. 1C is a side cutaway view of the battery housing 100 illustrating the battery cells 108 inside the frame structure 104.

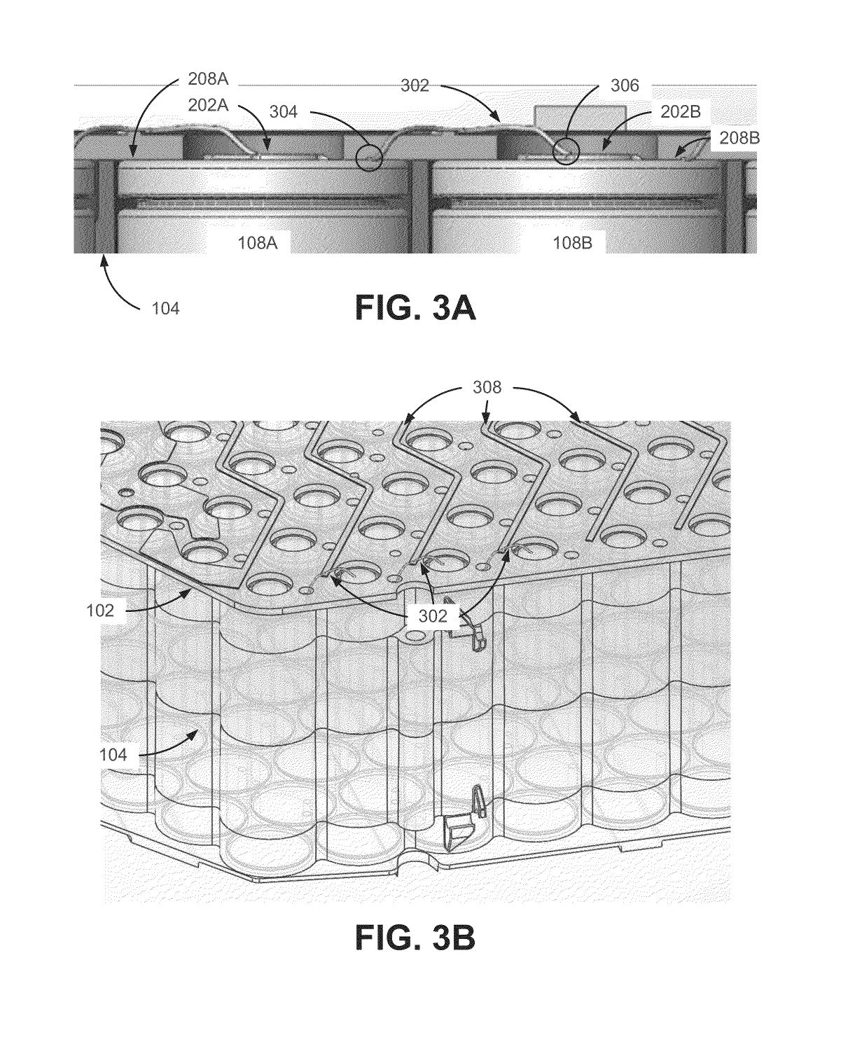

The circuit board 102 contains circuitry for electrically connecting the battery cells 108. In one embodiment, the circuit board 102 connects the battery cells 108 in a parallel-series configuration. In the parallel-series configuration, the cells 108 may be divided into groups of cells, where the cells in each group are connected in parallel and the groups are connected in series. In other embodiments, the circuit board 102 may connect the battery cells 108 in a different or more sophisticated manner. For example, groups of cells may be connected in series, and the series of groups may be connected in parallel with other series of groups to form a parallel-series-parallel configuration. Alternatively, the circuit board 102 may connect the battery cells in a series-parallel configuration or a series-parallel-series configuration. An example configuration for connecting the battery cells 108 is described in detail below with reference to FIGS. 3A-3B.

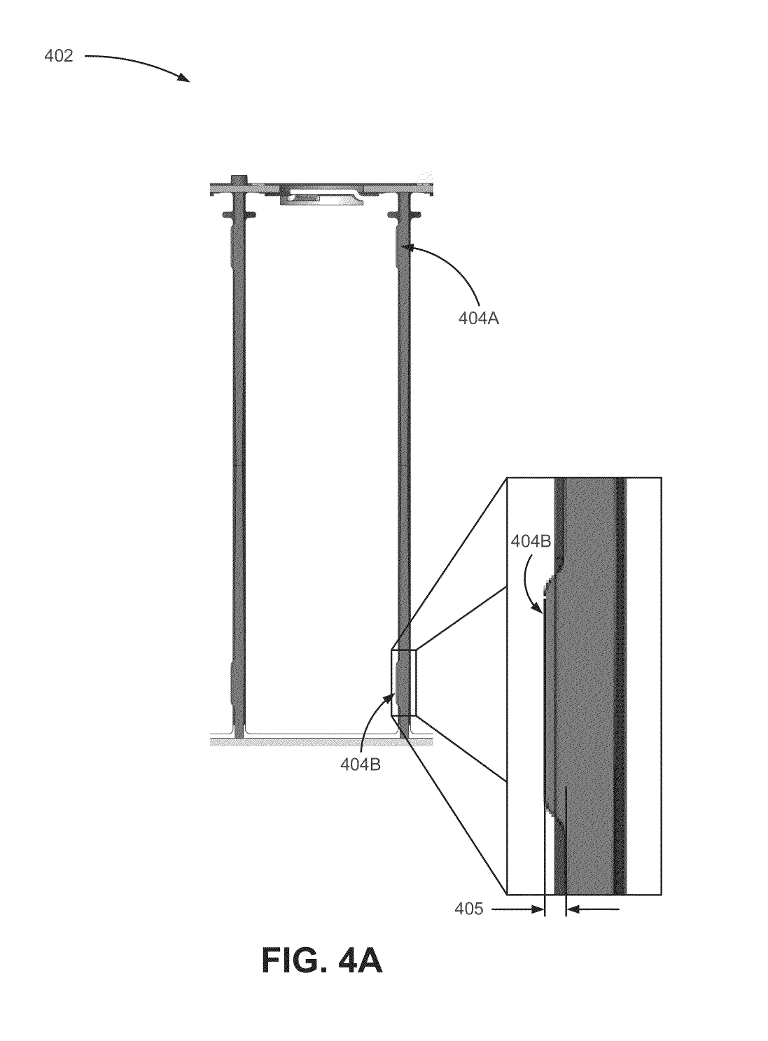

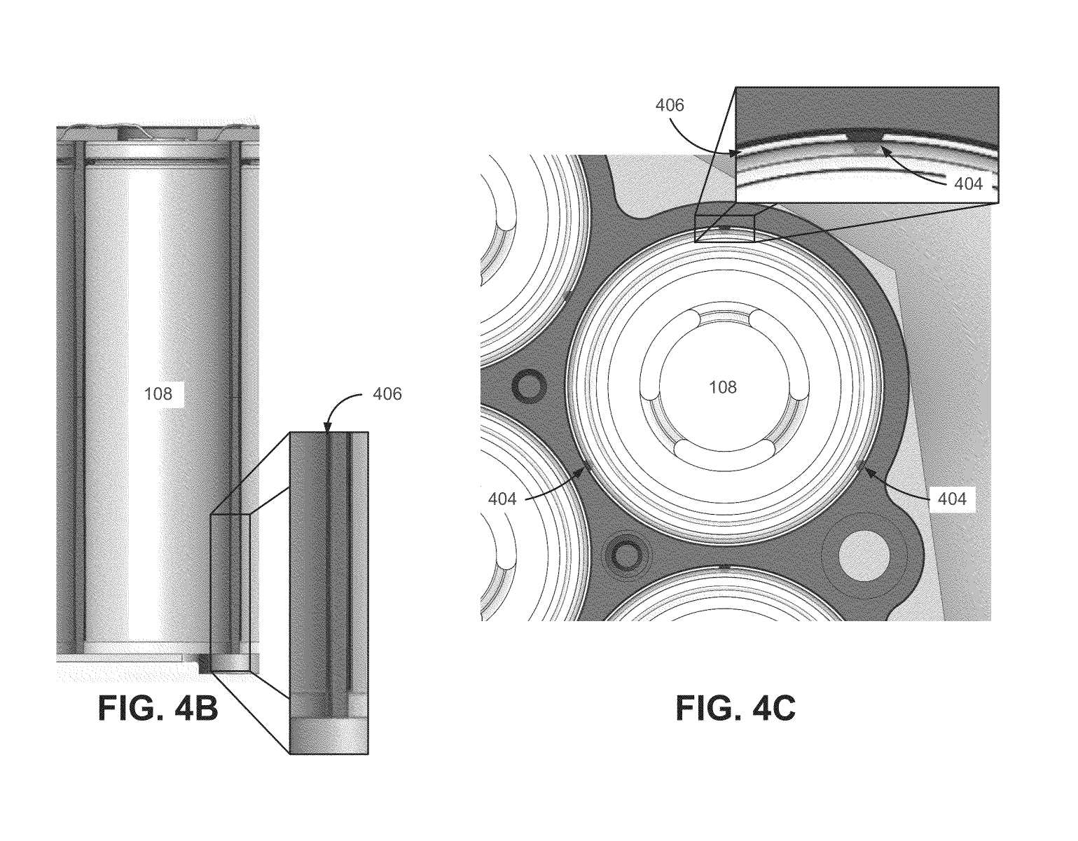

The frame structure 104 includes a plurality of cell compartments which provide mechanical support for the battery cells 108 within the battery housing. In the illustrated embodiment, the cell compartments in the frame structure 104 are separated into a left portion and a right portion, and the cell compartments in each portion hold battery cells 108 so that the cells are oriented substantially parallel to each other. In addition, the cell compartments are arranged in a hexagonal pattern to increase the packing efficiency of the battery cells 108 and reduce the amount of material used for the frame structure 104. Thus, each cell compartment that is not on the outer perimeter of the frame structure 104 is adjacent to six other cell compartments. In one embodiment, the frame structure 104 includes 126 cell compartments (e.g., 63 cell compartments in each portion), and each cell compartment holds a single battery cell 108. In this embodiment, each cell compartment has a volume of 17.3 cubic centimeters (cc), and the material used for the frame structure 104 occupies a volume of approximately 262 cc. As a whole, the frame structure 104 has a total volume of approximately 3000 cc when the volume of the cell compartments and the volume of other completely or partially enclosed regions are included. In other embodiments, the frame structure 104 includes additional or fewer cell compartments. The frame structure 104 can also include features that thermally isolate each battery cell 108 from adjacent battery cells to prevent adjacent cells from overheating when a single cell fails and releases a large amount of heat. An example method of achieving thermal isolation between battery cells is described below with reference to FIGS. 4A-4C.

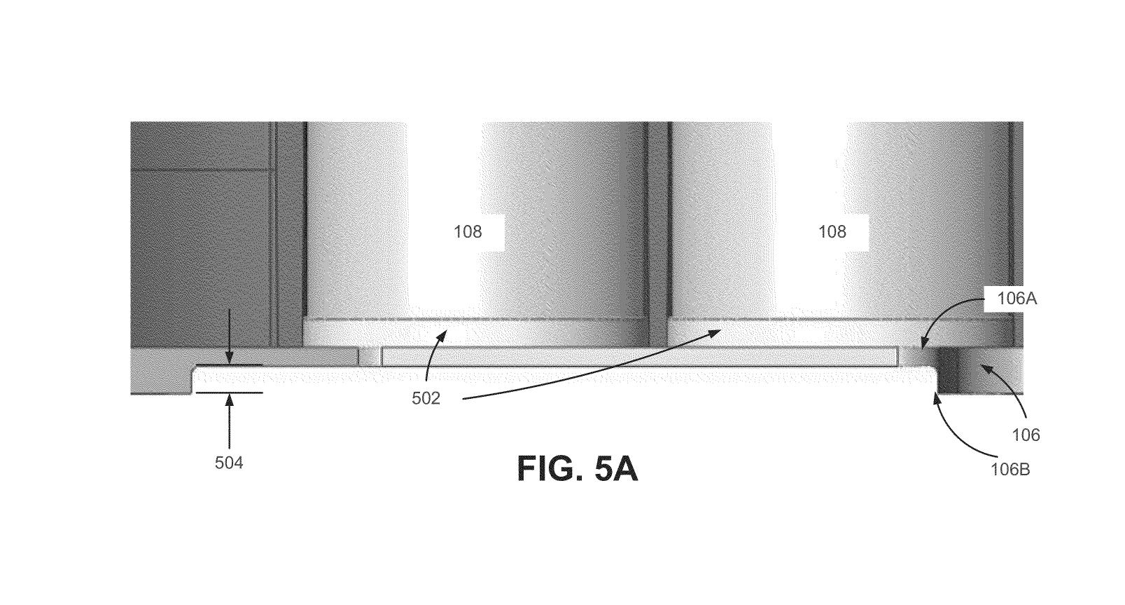

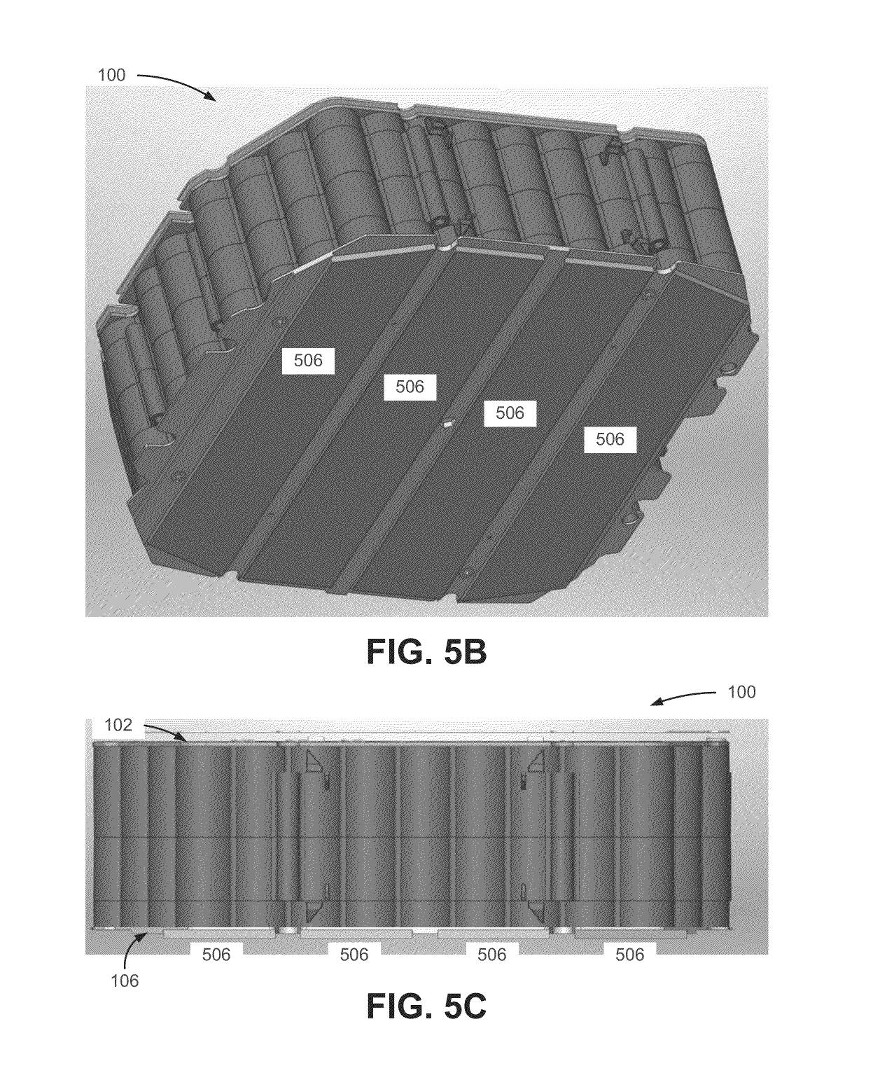

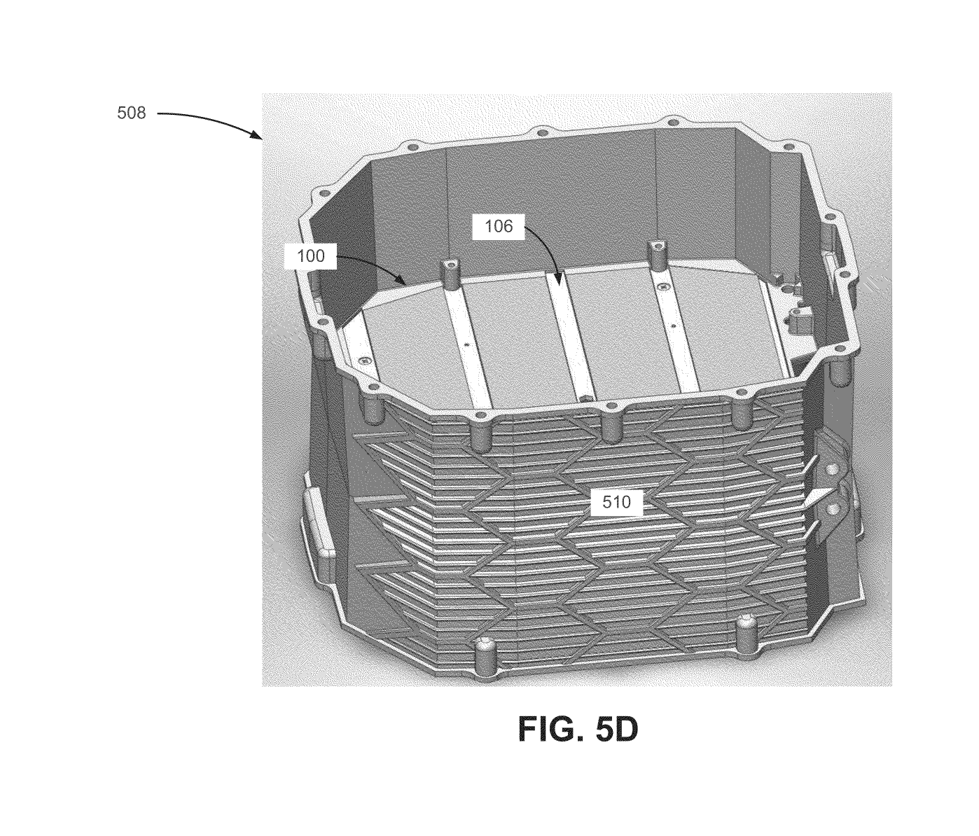

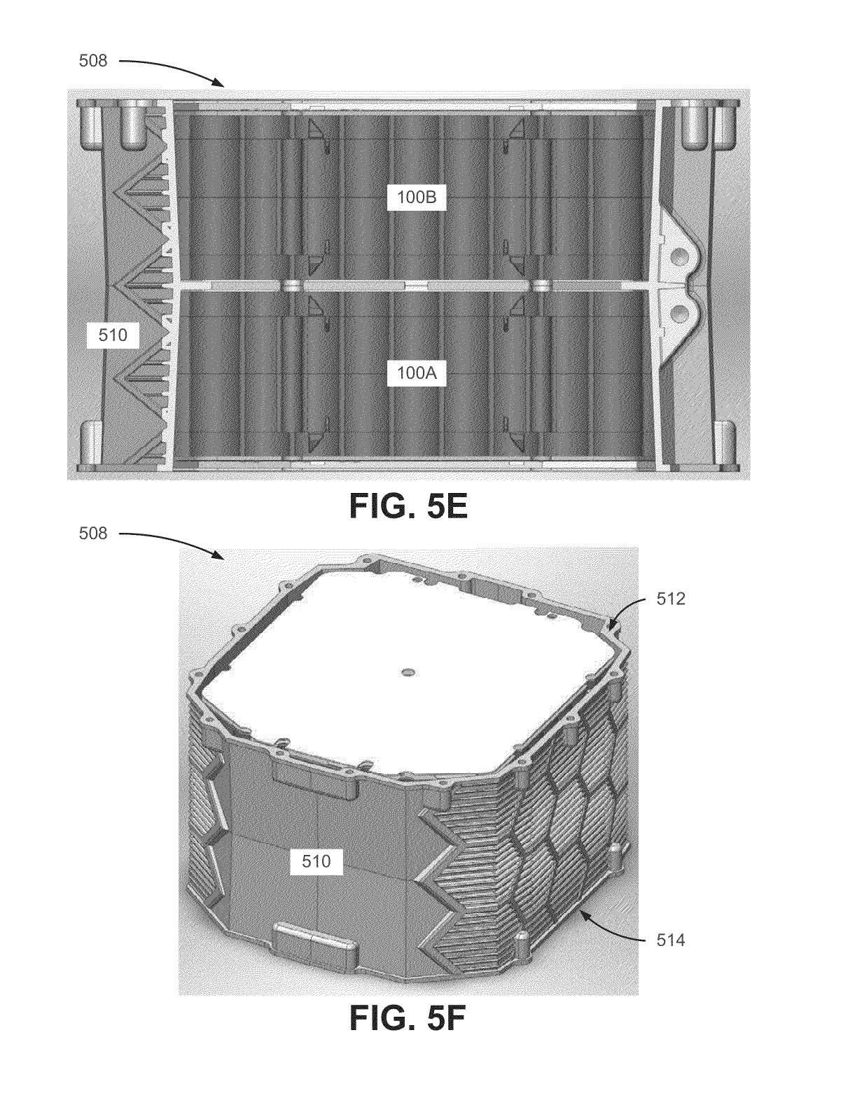

The heat spreader 106 is made of a thermally conductive material that transfers heat from the battery cells 108 to one or more heat dissipating devices. In one embodiment, one side 106A of the heat spreader 106 is thermally coupled to the battery cells 108, and the other side 106B of the heat spreader is coupled to other heat dissipating devices. The edges of the heat spreader 106 can also be coupled to heat dissipating devices. Examples of different configurations for using the heat spreader 106 to dissipate heat generated by the battery cells 108 are described in detail below with reference to FIGS. 5A-5C.

### Battery Cell Structure

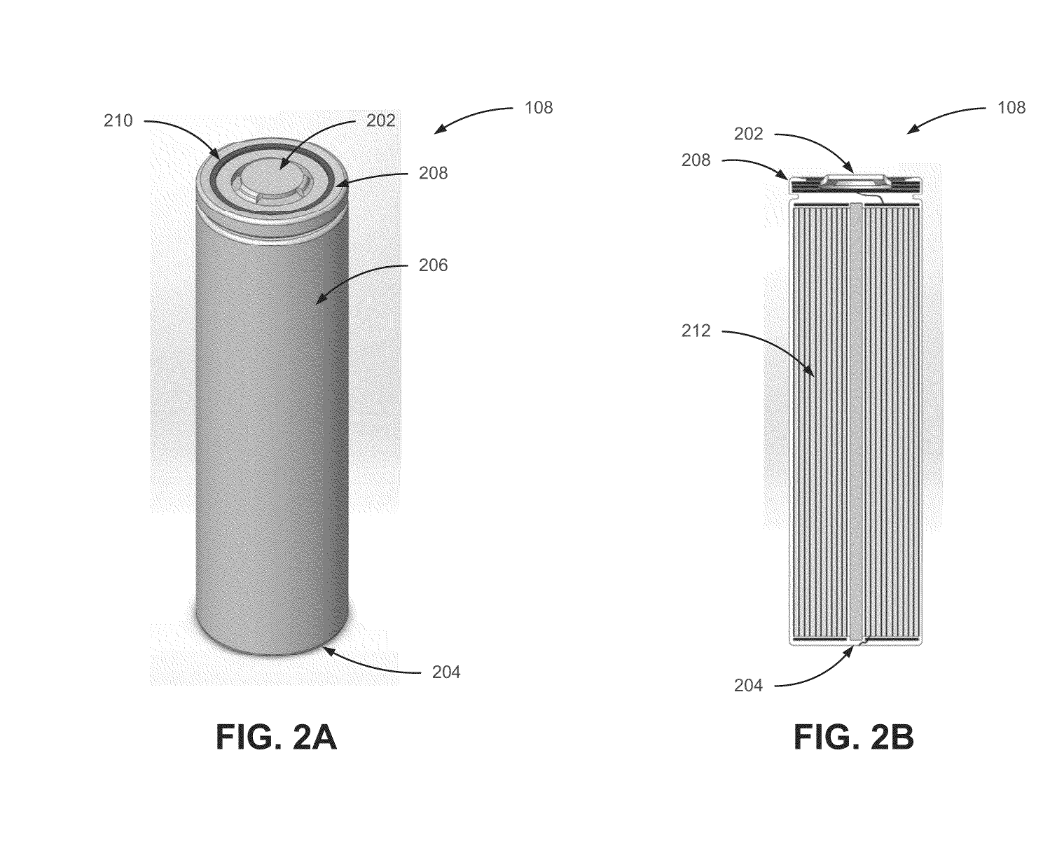

FIG. 2A is a perspective view of a cylindrical battery cell 108. The battery cell 108 is representative of the battery cells used in the battery housing 100. The battery cell 108 has a positive terminal 202 at a first end of the cell and a negative terminal 204 at a second opposite end of the cell. The battery cell 108 includes a conductive shell 206 that provides structural support and houses the internal components of the cell 108. The conductive shell 206 is formed of an electrically conductive material (e.g., metal) and is electrically coupled to the negative terminal 204 at the second end of the cell 108. The conductive shell 206 extends upward from the negative terminal 204 to a conducting structure 208 at the first end of the cell 108. In the embodiment shown in FIGS. 2A-2B, the conducting structure 208 comprises a crimp structure near the first end of the cell 108. A non-conductive ring 210 separates the conducting structure 208 from the positive terminal 202 to prevent electrical conduction between the positive terminal 202 and the conducting structure 208 (which is electrically coupled to the negative terminal 204 via the conductive shell 206).

FIG. 2B is a cross-sectional view illustrating the interior of the battery cell 108 shown in FIG. 2A. The interior of the cell 108 includes a jelly roll 212 and may optionally include other components, such as a vent tube to help with heat dissipation, a current interrupt device, and insulators at the ends of the jelly roll 212. The jelly roll 212 is an electrochemical component that stores and discharges electrical energy.

In one embodiment, the battery cells used in the battery housing 100 (e.g., the battery cell 108 shown in FIGS. 2A and 2B) are capable of producing a voltage of between 2.0 volts (V) and 4.2 V when fully charged. In addition, the battery cells are capable of producing a current of between −9 amperes (A) and 20 A. The voltage and current capabilities of the battery cells may decrease as the cells are discharged. Furthermore, in one embodiment the battery cells are energy-dense lithium ion cells with cylindrical form factors. In other embodiments, the battery cells may have different electrical, chemical, and mechanical properties, such as different output voltages and currents, different cell chemistry, and different form factors.

Conventionally, an electrical conductor is connected directly to the terminals 202, 204 at the opposing ends of the cell 108, and a thermal conductor is connected to the cylindrical surface of the cell 108. However, these conventional methods of making electrical and thermal contact with the cell 108 are unfavorable because the structure of the jelly roll 212 causes the bottom surface at the second end of the cell 108 (i.e., the negative terminal 204) to have a significantly higher thermal conductivity while the jelly roll 212 is being charged and discharged. Meanwhile, the cylindrical surface of the conductive shell 206 and the top surface at the first end of the cell 108 (i.e., the positive terminal 202) have a relatively lower thermal conductivity.

Instead of making electrical contact at opposing ends of the cell 108, electrical contacts for both the positive and negative terminals can be made at the first end of the cell 108. Since the conductive shell 206 is coupled to the negative terminal 204, an electrical conductor coupled to any portion of the shell 206 or the conducting structure 208 is also coupled to the negative terminal 204. Thus, a conductor contacting the portion of the conducting structure 208 on the first end of the cell 108 is coupled to the negative terminal via the conductive shell 206. This is particularly advantageous because the electrical interconnects between the positive terminal 202 of a cell and the negative terminal 204 of another cell can be placed at the same side of the battery frame 104 along the first ends of the cells, and the second ends of the cells (i.e., where thermal conductivity is higher) can be thermally coupled to a heat dissipation system (rather electrically coupled to an interconnect) at the opposite side of the battery frame 104. Furthermore, when thermal contact is made at the second end of the cell 108 rather than the cylindrical surface of the cell 108, an insulating system can be added adjacent to the cylindrical surface 206 to prevent a cell from transferring large amounts of heat to adjacent cells in the event of a failure (e.g., a thermal runaway).

### Single-Side Electrical Interconnects

FIG. 3A is a side cutaway view illustrating the interconnection between two adjacent battery cells 108A, 108B. The cells 108A, 108B are oriented in the frame structure 104 so that the first ends of both cells 108A, 108B are aligned with each other at a first side of the frame structure 104. In one embodiment, an interconnect 302 electrically connects the battery cells 108A, 108B. The interconnect 302 comprises electrically conductive material (e.g., copper or aluminum wires) that electrically connects a first cell 108A to a second cell 108B that is adjacent to the first cell 108A. The interconnect 302 is connected to the first cell 108A at a first contact point 304 and is connected to the second cell 108B at a second contact point 306. The contact points 304, 306 establish an electrical connection between a terminal of the corresponding cell 108 and the interconnect 302. For example, the contact points 304, 306 may be stitch bonds.

In the illustrated embodiment, the first contact point 304 is formed at the conducting structure 208A of the first cell 108A, and the second contact point 306 is formed at the positive terminal 202B of the second cell 108B. Thus, the interconnect 302 couples the negative terminal of the first cell 108A to the positive terminal of the second cell 108B to connect the cells 108A, 108B in series. In other embodiments, interconnects 302 may be configured to electrically couple two negative terminals (e.g., with contact points formed at the conducting structures of two cells) and/or two positive terminals (e.g., with contact points formed at the positive terminals of two cells) to create a parallel connection between two cells. Interconnects 302 may additionally be combined in the manners described above to create more sophisticated connections between multiple cells, such as series-parallel connections and parallel-series connections. In still other embodiments, the interconnect 302 may have a different shape or be formed out of a different material, such as gold or silver.

Since the contact points 304, 306 for both terminals of the cell 108 are formed at the first end of the cell 108, the entire interconnect 302 is positioned at the first side of the frame structure 104. Thus, the interconnect 302 can be shorter in length than interconnects in conventional battery housings. Shorter interconnects 302 are beneficial because they allow for lower material and manufacturing costs. For further reduced costs, the interconnect 302 can be formed of a single piece of conductive material. For example, the interconnect 302 can be a single wire.

FIG. 3B is a perspective view of the battery housing 100 illustrating three interconnects 302 between adjacent battery cells 108. FIG. 3B also illustrates conducting traces 308 on the circuit board 102, which is positioned at the first side of the frame structure 104. The interconnects 302 can be connected to the traces 308 to create additional connections between the battery cells 108. In one embodiment, an ultrasonic welding process is used to create an electrical connection between the interconnects 302 and the traces 308. The connection can alternatively be formed using a different method, such as resistance welding, laser welding, or a mechanical joint or fastener (e.g., a screw). The traces 308 can thus be used to establish parallel connections between groups of cells 308 that have been connected in series with interconnects 302. In one embodiment, the traces 308 are also connected to a voltage monitoring system that monitors the voltage of the battery cells 108.

Although only three interconnects 302 are shown in FIG. 3B, the interconnects 302 and conducting traces 308 may be used in the manner described above to connect all of the cells 108 in the frame structure 104. In one embodiment, the interconnected cells 108 in a single frame structure 104 provide a total output voltage of between 52.5 V and 55.2 V and a total output current of between −54 A and 120 A when fully charged.

The interconnect 302 between two battery cells 108 may optionally function as a fuse that breaks (i.e., disconnects) the electrical connection that it forms between two battery cells 108 when the current through the interconnect 302 exceeds a threshold current that would damage other electrical components of the battery housing 100. For example, the material and the cross section of the interconnect 302 may be selected so that the heat generated by any current greater than the threshold current causes the interconnect 302 to melt or otherwise become disconnected. Configuring an interconnect 302 to function in this manner can further reduce material costs of the battery housing 100 by reducing or eliminating the need for dedicated fuses or other current regulating devices. In one embodiment, every interconnect 302 in the battery housing 100 is configured to function as a fuse in this manner. In other embodiments, only a subset of the interconnects 302 are configured to function as fuses.

### Thermal Insulation

FIG. 4A illustrates a cell compartment 402 within the frame structure 104, according to one embodiment. The cell compartment 402 includes a plurality of alignment features 404 (or ribs) at the top and bottom of the compartment 402 that make contact with a battery cell 108 within the compartment 402. In one embodiment, each alignment feature 404 protrudes from an interior surface of the cell compartment 402 by a protrusion distance 405. To prevent undesired electrical or thermal conduction between cells, the frame structure 104 and alignment features 404 are made of a material with a low electrical conductivity and a low thermal conductivity. For example, the frame structure 104 and alignment features 404 may be made of plastic.

FIG. 4B is a side cutaway view of a battery cell 108 in contact with the alignment features 404 inside the cell compartment 402, and FIG. 4C is a top view of the battery cell 108 inside the cell compartment 402. As shown in FIGS. 4B and 4C, the alignment features 404 create an air gap 406 between the battery cell 108 and the interior surface of the cell compartment 402 when the cell 108 is in contact with the alignment features 404. The thickness of the air gap 406 is defined by the protrusion distance 405 of the alignment features 404. In one embodiment, the air gap thickness is the same as the protrusion distance 405. The alignment features 404 also center the battery cell 108 in the compartment 402 so that the air gap 406 has a consistent thickness around the entire cylindrical surface of the battery cell 108.

In the illustrated embodiment, a first set of three alignment features 404 is formed at a first end of the cell compartment (at the first side of the frame structure 104) and a second set of three alignment features 404 is formed at a second end of the cell compartment (at the second side of the frame structure 104). In both sets, the three alignment features 404 extend along a longitudinal direction of the battery cell compartment and are spaced 120 degrees apart from each other. In other embodiments, a different number, spacing, or orientation of alignment features 404 may be used. For example, the cell compartment 104 may include three alignment features 404 that extend from the first end to the second end of the cell compartment 104.

Since the protrusion distance 405 defines the thickness of the air gap 406, the protrusion distance 405 can be selected so that the resulting air gap 406 has a thickness that is large enough for the air to provide thermal insulation between the cell 108 and the frame structure 104 but small enough that a significant amount of convection does not occur within the air gap 406. In one embodiment, the alignment features 404 have a protrusion distance 405 that is greater than 0.1 mm but less than 0.5 mm, thus creating an air gap 406 of approximately the same thickness between the cylindrical surface of the cell 108 and the inner surface of the cell compartment 402. In another embodiment, the alignment features 404 have a protrusion distance 405 of less than 2 mm.

The air gap 406 between the cylindrical surface of the cell 108 and the inner surface of the cell compartment 402 reduces heat transfer due to conduction or convection between adjacent battery cells 108 in the frame structure 104. In addition, heat transfer is further reduced because the interior surface of each cell compartment surrounds the cylindrical surface of the corresponding battery cell 108. As a result, the frame structure 104 provides a physical barrier between adjacent cells 108, which reduces thermal radiation between the cells 108. It is advantageous to reduce heat transfer between adjacent battery cells 108 because this protects adjacent cells when a cell fails and releases a large amount of heat, such as during a thermal runaway. Instead, the excess heat generated when a thermal failure occurs in a cell 108 is transferred to the heat spreader 106, which in turn distributes the excess heat to the other cells in a more even manner and transfers the heat to heat dissipating surfaces, as described below in FIGS. 5A-5F. Thus, the air gap 406 created by the alignment features 404 reduces the likelihood of damage to adjacent cells in the event of a thermal failure in a single cell 108 and allows for a higher packing density of cells in the frame structure 106.

### Thermal Interface and Thermal Management System

FIG. 5A is a side cutaway view illustrating a thermal interface 502 between the battery cells 108 and the heat spreader 106, according to one embodiment. In one embodiment, the heat spreader 106 is positioned at the second side of the battery frame 104 opposite to the circuit board 104 and the interconnects 302. The thermal interface 502 contacts the second ends of the battery cells 108 and the first side 106A of the heat spreader 106 to thermally connect the battery cells 108 to the heat spreader 106. The battery cells 108 may be positioned to make the second ends substantially coplanar, which allows the thermal interface 502 to have approximately the same thickness between the heat spreader 106 and each connected battery cell 108.

Since the thermal interface 502 thermally connects the battery cells 108 to the heat spreader 106, the interface 502 allows heat to be transferred from the battery cells 108 to the heat spreader 106. The interface 502 can be made of any material with a high thermal conductivity to facilitate heat transfer and a low electrical conductivity to inhibit electrical conduction between the cell 108 and the heat spreader 106. In one embodiment, the interface 502 is epoxy. Alternatively, a potting compound, a thermal paste, or a thermal interface material (e.g., a thermal pad or carbon sheet) can be used as the interface 502. In embodiments where the thermal interface 502 is used in conjunction with the single-side electrical interconnects 302 described above with reference to FIGS. 3A-3B, the thermal interface 502 can be made of a single layer of material without the need for additional layers of material to electrically connect to the negative terminals at the second ends of the cells. For example, the interface 502 can be a single layer of epoxy. Using a single layer of material for the thermal interface 502 beneficially reduces material costs and simplifies the process of applying the thermal interface 502 between the second ends of the battery cells and the heat spreader 106.

In other embodiments, the thermal interface 502 is made of a material with a higher electrical conductivity, and the heat spreader 106 has a non-conductive plating or coating to inhibit electrical conduction between the cells 108 and the heat spreader 106. For example, the heat spreader 106 may be formed of anodized aluminum.

Similarly, the heat spreader 106 is also made of a material with a high thermal conductivity. However, since the thermal interface 502 has a low electrical conductivity that inhibits electrical conduction between the cells 108 and the heat spreader 106, there are fewer constraints on the electrical conductivity of the material used for the heat spreader 106. In one embodiment, the heat spreader 106 is formed of aluminum. In another embodiment, the heat spreader 106 is formed of a different material with a high thermal conductivity, such as copper. In still another embodiment, the head spreader is a two-phase heat transfer device (e.g., a heat pipe) that includes heat transfer material in two difference states of matter.

The second side 106B of the heat spreader 106 can optionally include indentations 504 that can be used to couple the heat spreader 106 to other thermal regulating devices. For example, pieces of heat transfer material 506 (e.g., copper) that have a higher thermal conductivity than the heat spreader 106 can be placed in the indentations 504 to improve heat transfer between different positions in the heat spreader 106, as shown in the perspective view of FIG. 5B and the side view of FIG. 5C. In one embodiment, thermal paste or some other heat transfer medium is added between the heat transfer material 506 and the heat spreader 106 to provide an improved thermal interface between the two components 106, 506. Alternatively, the thermal paste is omitted (e.g., to reduce material or assembly costs), and a surface of the heat transfer material 506 is placed in physical contact with a surface of the heat spreader 106.

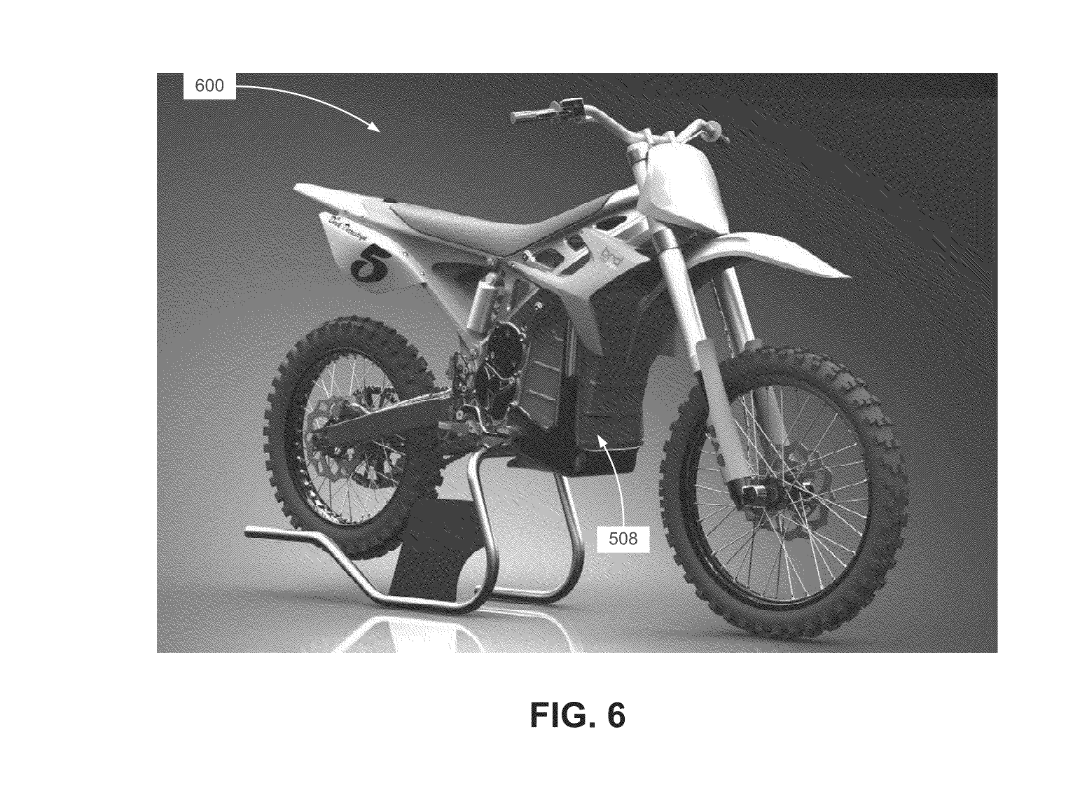

FIG. 5D is a perspective view of a battery assembly 508, according to one embodiment. The battery assembly 508 includes one or more battery housings 100 inside a battery enclosure 510. To further improve the effectiveness of the heat spreader 106, the heat spreader 106 can be thermally coupled to the battery enclosure 510 to provide a thermal conduction path from the battery cells 108 to the exterior of the assembly 508. Coupling the heat spreader 106 to the enclosure 510 is especially advantageous when the battery assembly 508 is used on a moving object where it can frequently be exposed to moving air, such as when the battery assembly 508 is part of an electric motorcycle as shown in FIG. 6, because the exposure to moving air allows for significant convective heat transfer on the external surface of the enclosure 510.

In some embodiments, the external surface of the enclosure 510 includes a plurality of external ridges and other elevated patterns. This increases the external surface area of the enclosure 510 and allows for improved heat dissipation.

The heat transfer material 506 can additionally be used to thermally couple the heat spreader 106 to the heat spreader of a second battery housing. FIG. 5E is a side view of a battery assembly 508 containing two battery housings 100A, 100B thermally coupled together with heat transfer material 506, and FIG. 5F is a perspective view of the battery assembly 508. As shown in FIG. 5E, the second side of one heat spreader (i.e., the side opposite to the battery cells) is thermally coupled to the second side of the other heat spreader. The second side of both heat spreaders can also be coupled to pieces of heat transfer material. In one embodiment, the heat spreaders are thermally coupled to each other with thermal grease, a thermal pad, or some other thermal interface material. In another embodiment, the thermal interface material is omitted and the second sides of the heat spreaders are placed in physical contact with each other.

In embodiments where two battery housings are desired (e.g., for a battery assembly 508 with a larger total storage capacity), it is advantageous to thermally couple the heat spreaders 106 of the two battery housings 100A, 100B in the manner shown in FIGS. 5E and 5F because the coupling forms a thermal conduction path between the cells 108 of both battery housings. Thus, in addition to dissipating heat generated by the cells 108, the temperatures of the cells 108 in both housings can be held close together.

Furthermore, the enclosures 510 of multiple battery assemblies 508 can be thermally coupled (e.g., at the top and bottom surfaces 512, 514) when a battery system with an even larger total capacity is desired. This forms a thermal conduction path between the cells 108 of the multiple battery assemblies 508 and allows for heat transfer between the battery assemblies 508.

In other embodiments, additional or different temperature regulating devices may be integrated into the battery assembly 508. For example, an active liquid or air cooling system may be thermally coupled to the heat spreader 106, the enclosure 510, or some other component of the battery assembly 508. Similarly, additional passive cooling devices, such as heat sinks, heat pipes, or heat spreaders, may be coupled to components of the battery assembly 508. In still other embodiments, the battery assembly 508 may further include a feedback temperature controller that monitors temperatures throughout the assembly 508 and adjusts active cooling systems to maintain a particular temperature.

FIG. 6 illustrates a battery assembly 508 mounted on an electric motorcycle 600, according to one embodiment. In the electric motorcycle 600 shown in FIG. 6, the battery assembly 508 provides sufficient electrical power to power other components of the motorcycle 600, such as an electric motor used to drive the motorcycle 600 and a throttle for controlling the speed of the motorcycle 600. As described above, it is advantageous to use the battery assembly 508 with a battery enclosure that is coupled to heat spreaders inside the battery assembly 508 because the battery enclosure is exposed to moving air while the motorcycle 600 is in motion.

Although the battery assembly 508 shown in FIG. 6 is configured to fit in the frame of the electric motorcycle 600, the battery assembly 508 described herein may alternatively be used in other applications. For example, the battery assembly 508 may be used as part of an electric automobile, an airplane, or to store electric energy generated by a stationary electric generator. In addition, each of the features described herein with respect to the battery housing 100 and the battery assembly 508 may be applied to other devices independently of other features described herein. For example, the single-side electrical interconnects described with reference to FIGS. 3A-3B may be used to connect battery cells in a device that does not include the alignment features described with reference to FIGS. 4A-4C or the heat dissipation features described with reference to FIGS. 5A-5F.

Upon reading this disclosure, those of skill in the art will appreciate still additional alternative designs for a battery housing. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein.

What is claimed is:

1. A battery housing comprising:
a battery frame containing a plurality of battery cells, each battery cell having a first end and a second end opposite the first end, each battery cell including:
a positive terminal located at the first end of the battery cell,
a conducting structure located at the first end of the battery cell and electrically isolated from the positive terminal, and
a negative terminal located at the second end of the battery cell, the negative terminal electrically coupled to the conducting structure,
wherein at least some of the battery cells are oriented in the battery frame so that the first ends of the battery cells are aligned with each other; and
a plurality of interconnects electrically connecting the battery cells, the interconnects making electrical connections to the positive terminals and to the conducting structures of the battery cells.

2. The battery housing of claim 1, wherein at least one interconnect consists of a single piece of electrically conductive material.

3. The battery housing of claim 1, wherein the conducting structure comprises a crimp structure.

4. The battery housing of claim 3, wherein each battery cell further includes a conductive shell electrically coupling the negative terminal to the crimp structure.

5. The battery housing of claim 1, further comprising:
first stitch bonds attaching at least some of the interconnects to the crimp structures; and
second stitch bonds attaching at least some of the interconnects to the positive terminals.

6. The battery housing of claim 1, further comprising:
a circuit board positioned in close proximity to the first ends of the battery cells, the circuit board including a conductive trace electrically coupled to two or more of the battery cells.

7. The battery housing of claim 6, wherein the conductive trace is also electrically coupled to a voltage monitor.

8. The battery housing of claim 1, wherein the interconnects create a series connection between at least two of the battery cells.

9. The battery housing of claim 1, wherein the interconnects create a parallel connection between at least two of the battery cells.

10. The battery housing of claim 1, wherein the interconnects create a series connection between at least two groups of battery cells, and the interconnects further create a parallel connection between battery cells within each group.

11. The battery housing of claim 1, wherein the interconnects create a parallel connection between at least two groups of battery cells, and the interconnects further create a series connection between battery cells within each group.

12. The battery housing of claim 1, wherein at least one interconnect is configured to break its electrical connection responsive to a current through the interconnect exceeding a threshold current.

13. The battery housing of claim 1, wherein the battery frame contains at least 126 battery cells.

14. The battery housing of claim 1, wherein the interconnected battery cells are capable of producing a voltage of between 52.2 volts and 55.2 volts.

15. The battery housing of claim 1, wherein the interconnected battery cells are capable of producing a current of between −54 amperes and 120 amperes.

15. The battery housing of claim 1, wherein the battery cells are hexagonally packed within the battery frame.

16. The battery housing of claim 1, wherein the battery cells are oriented in the battery frame so that the second ends of the battery cells are coplanar.

17. The battery housing of claim 1, wherein the battery cells are cylindrical in shape.

18. The battery housing of claim 1, wherein the battery housing is configured to fit in a frame of a motorcycle and the battery cells are sufficient to power the motorcycle.

19. The battery housing of claim 1, wherein the battery cells are lithium ion cells.
